(19) United States
(12) Patent Application Publication
(10) Pub. No.: US 2014/0299686 A1
(43) Pub. Date: Oct. 9, 2014

(54) HIGH THROUGHPUT NUT GRINDER

(71) Applicant: COUNTRY LIVING PRODUCTIONS, INC., Stanwood, WA (US)

(72) Inventors: JACK R. JENKINS, Stanwood, WA (US); JOEL A. JENKINS, Marysville, WA (US); ALEX M. SMITH, Arlington, WA (US)

(73) Assignee: COUNTRY LIVING PRODUCTIONS, INC., Stanwood, WA (US)

(21) Appl. No.: 14/247,237

(22) Filed: Apr. 7, 2014

Related U.S. Application Data
(63) Continuation-in-part of application No. 13/112,972, filed on May 20, 2011, now Pat. No. 8,690,092.

(51) Int. Cl. B02C 18/30; A23L 1/38

(52) U.S. Cl. CPC B02C 18/305; A23L 1/38
USPC 241/27; 241/246

(57) ABSTRACT

A high capacity nut grinder includes an auger configured to slice nuts as they are received from a hopper and convey the nuts from the hopper to a receiving volume between a pair of grinding plates. Optionally, the nut grinder can include a sleeve including an asymmetrical aperture configured to cooperate with the nut auger to slice nuts without expelling nuts upward into the nut hopper.

### CROSS-REFERENCE TO RELATED APPLICATIONS

The present application is a Continuation-in-Part of, and claims priority from co-pending U.S. patent application Ser. No. 13/112,972, entitled “NUT GRINDER”, filed May 20, 2011; which claims priority benefit from U.S. Provisional Patent Application No. 61/346,864, entitled “NUT GRINDER”, filed May 20, 2010; each of which, to the extent not inconsistent with the disclosure herein, is incorporated by reference.

### BACKGROUND

FIG. 1A is a perspective view of a grain grinder 101 made according to the prior art. FIG. 1B is a side sectional view of the grain grinder 101 of FIG. 1A. Referring to FIGS. 1A and 1B, the grain grinder 101 includes a body 102 that defines a cylindrical conveying volume 104 positioned to convey grain from an input hopper 108 to a pair of grinding plates 112, 120. A shaft 111 is supported by bearings 128 and is positioned axially to the conveying volume 104. The shaft 111 supports a spring auger 106 that turns with the shaft to urge grain from the hopper end of the conveying volume to the pair of grinding plates 112, 120 at the output end of the cylindrical conveying volume 104. A stationary grinding plate 112 is coupled to the body 102 and positioned circumferentially to the shaft 111 such that grain may pass through an inner diameter of the stationary grinding plate 112. The grain is conveyed by the spring auger 106 to a receiving volume (not shown in FIGS. 1A and 1B) formed between depressions in grinding surfaces of the stationary grinding plate 112 and a rotatable grinding plate 120. A hand crank 122 can be disposed to receive human power to rotate the shaft 111, the spring auger 106, and the rotatable grinding plate 120 relative to the body 102, cylindrical conveying volume 104, and stationary grinding plate 112. The spring auger 106 urges grain from the hopper 108 to a nip between the grinding plates 112, 120. The receiving volume (not shown) may be comprised of facing hollowed sections of the grinding surfaces and configured to receive grain for initial grinding and movement to contacting regions of the grinding surfaces of the grinding plates 112, 120 located around the periphery of the grinding plates 112, 120. Grinding action between the stationary grinding plate 112 and the rotatable grinding plate 120 mills the grain into flour. In an embodiment, the stationary grinding plate 112 and the rotatable grinding plate 120 are about 5 inches in diameter.

Optionally, a person may provide a power source to the shaft 111. For example, the hand crank 122 can be operatively coupled the shaft 111. A person may provide rotational motion to the shaft 111, the spring auger 106, and the rotatable grinding plate 120. Alternatively, a person or a motor can provide rotational motion to a pulley 126 that may include a V-groove capable of receiving rotational energy from a V-belt (not shown). The V-belt can be coupled to a human-powered source such as a stationary bicycle or can be operatively coupled to a motor. In some embodiments, a motor used to provide rotational power can provide greater rotational power and torque than a person might be capable of providing. In other embodiments, the motor can be constrained to provide no more rotational power than that which a person is capable of providing.

### SUMMARY

According to an embodiment, a nut grinder includes a body defining a cylindrical conveying volume having an input end, an output end, and an axis. A first grinding plate defines a first grinding surface operatively coupled to the body and disposed adjacent to the output end of the conveying volume. A rotating shaft is supported axial to and configured to rotate in the conveying volume. A second grinding plate defines a second grinding surface operatively coupled to the shaft, and is configured to be held in at least partial sliding rotational contact with the first grinding surface and receive rotational motion from the shaft. A nut auger is disposed coaxially with and in the conveying volume, is configured to receive rotational motion from the shaft, is configured to receive nuts from a hopper at or near the input end of the conveying volume, and is configured to convey the nuts to the output end of the conveying volume to a receiving volume defined by the first and second grinding surfaces. The nut auger is configured to slice nuts as nuts are fed by gravity from the hopper.

According to an embodiment, a method for grinding nuts includes receiving nuts from a hopper by gravity feed alone, rotating a nut auger to convey the received nuts to a receiving volume defined between a pair of grinding surfaces defined by respective grinding plates, and extruding a nut butter from a region between outer edges of the grinding surfaces. One of the grinding plates is stationary and the other of the pair of grinding plates rotates synchronously with the nut auger.

### BRIEF DESCRIPTION OF THE FIGURES

FIG. 1A is a perspective view of a grain grinder made according to the prior art.

FIG. 1B is a side sectional view of the grain grinder of FIG. 1A.

FIG. 2A is a perspective exploded view of a grinder configured to grind nuts, according to an embodiment.

FIG. 2B is side sectional view of the grinder of FIG. 2A, according to an embodiment.

FIG. 3A is a dimensioned side view of an auger configured to convey nuts in the grinder of FIGS. 2A and 2B, according to an embodiment.

FIG. 3B is a detail view of a thread included in the auger shown in FIG. 3A, according to an embodiment.

FIG. 3C is a dimensioned end view of the auger configured to convey nuts shown in FIGS. 3A and 3B, according to an embodiment.

FIG. 4A is a view of a grinding surface of a rotatable grinding plate configured to grind nuts in the grinder of FIGS. 2A and 2B, according to an embodiment.

FIG. 4B is a dimensioned side view of the rotatable grinding plate of FIG. 4A, according to an embodiment.

FIG. 5A is a dimensioned view of a grinding surface of a fixed grinding plate and an attached sleeve configured for use in the grinder of FIGS. 2A and 2B, according to an embodiment.

FIG. 5B is a dimensioned side view of the fixed grinding plate and attached sleeve of FIG. 5A, according to an embodiment.

FIG. 5C is a dimensioned view of a mounting surface of the sleeve and attached fixed grinding plate shown in FIGS. 5A and 5B, according to an embodiment.

FIG. 6 is a perspective exploded view of a nut grinder configured to grind nuts, according to another embodiment.

FIG. 7 is a perspective exploded view of a nut grinder configured to grind nuts, according to another embodiment.

FIG. 8 is an end view of a sleeve, according to an alternative embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or and other changes may be made without departing from the spirit or scope of the disclosure.

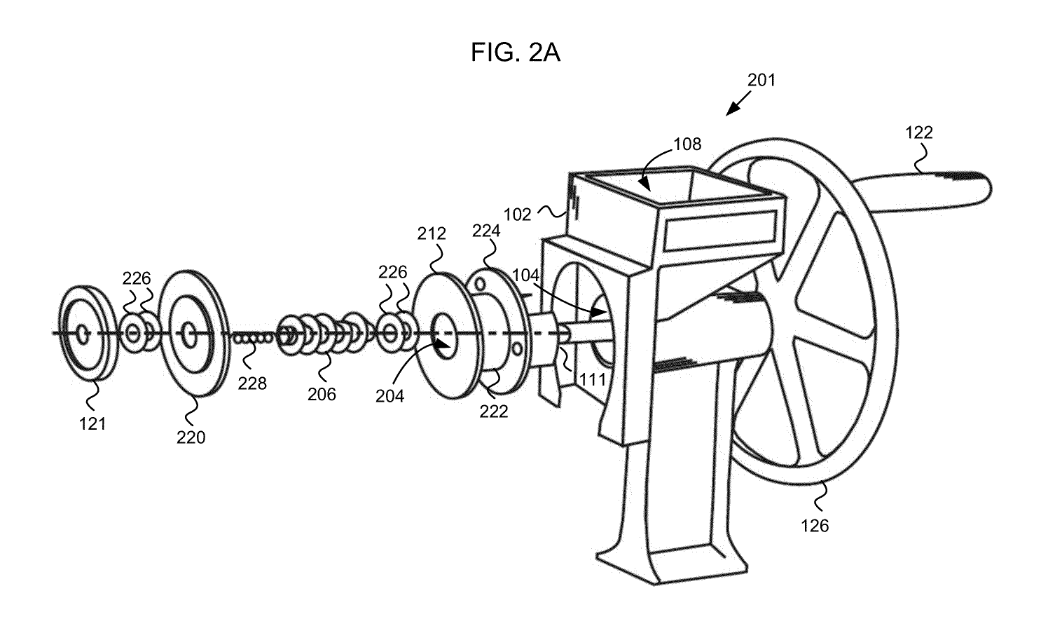

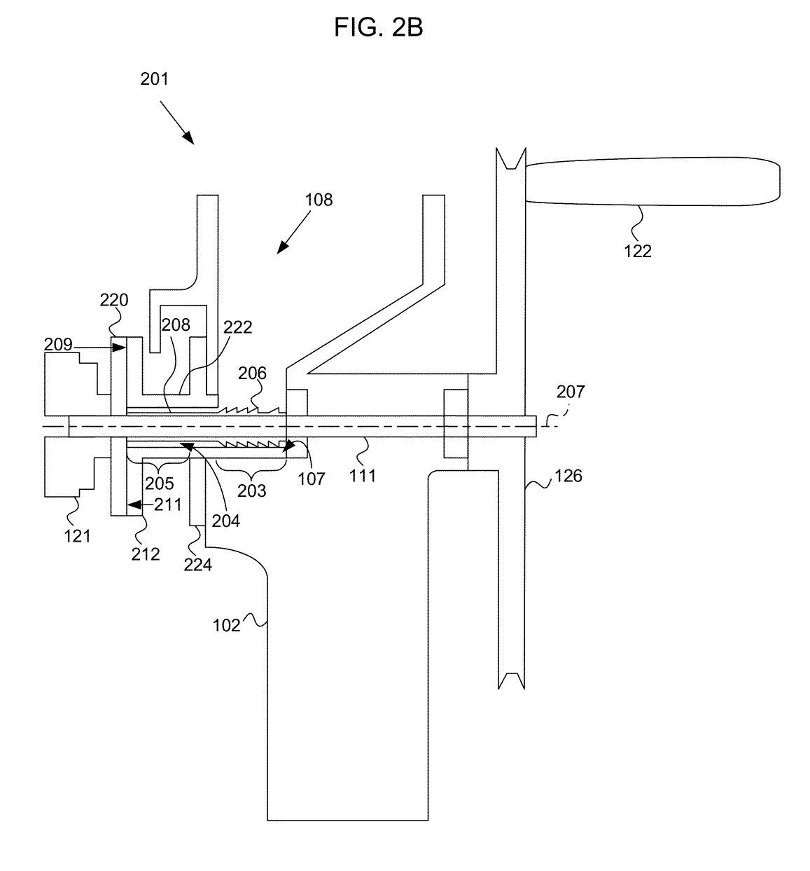

FIG. 2A is a perspective exploded view of a nut grinder 201 configured to grind nuts, according to an embodiment. FIG. 2B is side sectional view of the nut grinder 201 of FIG. 2A, according to an embodiment.

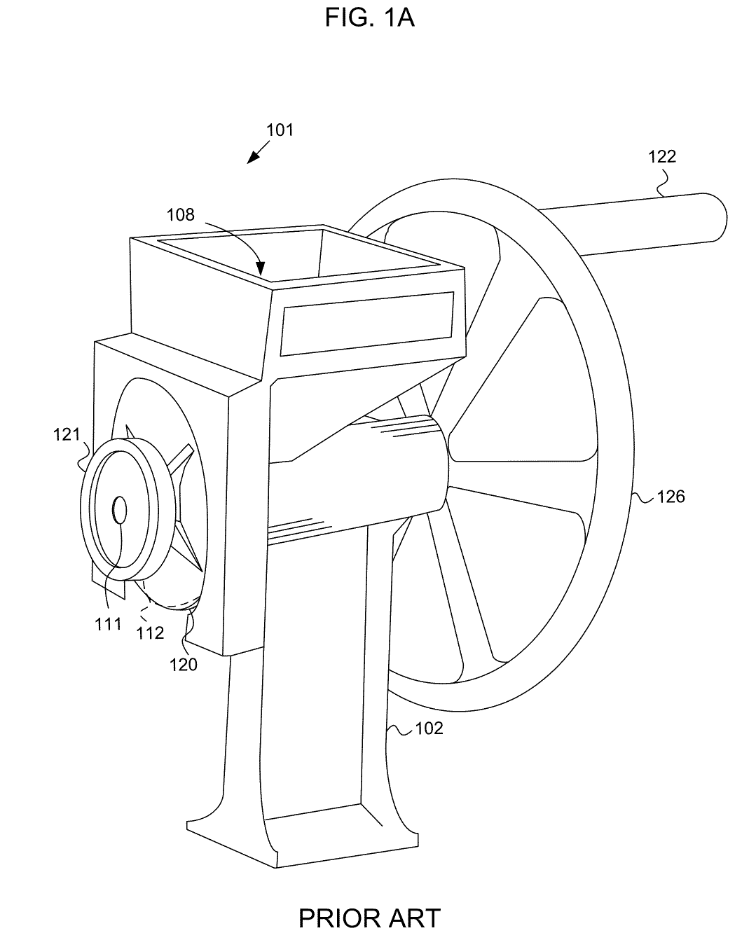

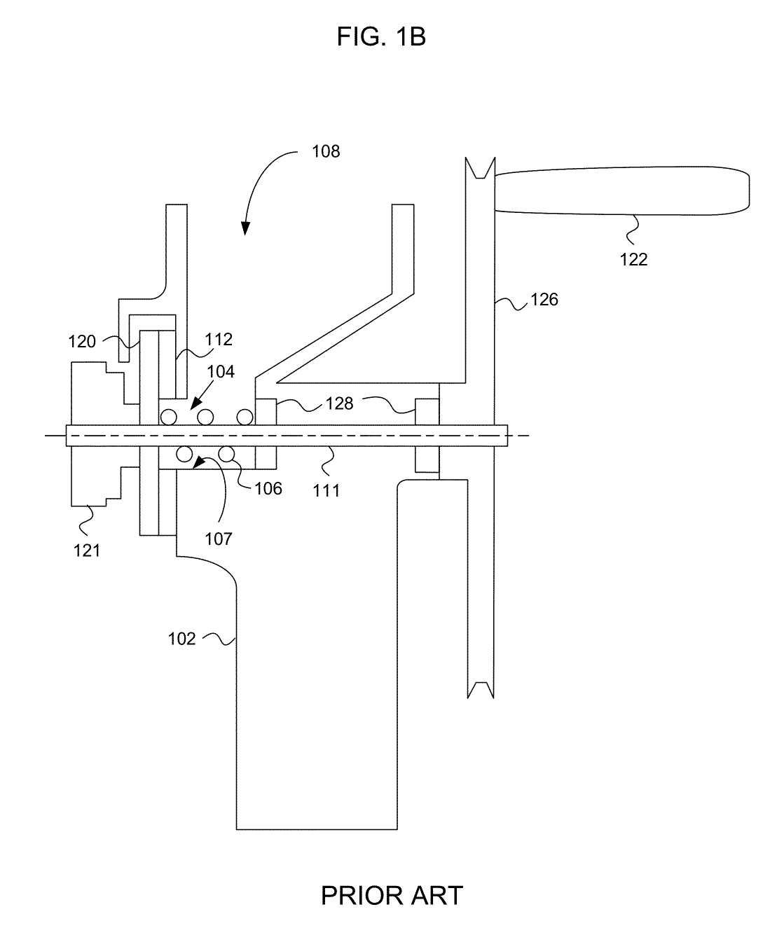

Referring to FIGS. 2A and 2B, the nut grinder 201 may include portions of the grain grinder 101 of FIGS. 1A, 1B, for example, by removing some parts and installing a conversion kit, described below. Referring especially to FIG. 2A, a sleeve 222 including an inner wall 204 defining an axially symmetric conveying volume may be mounted on the grinder body 102 with a flange 224. The flange 224 is also referred to as a collar 224 herein. The sleeve 222 may include an integral or assembled fixed grinding plate 212. One or more shims (e.g., flat washers) 226 may then be inserted over the shaft 111, such as to form thrust bearings. A nut auger 206 is next mounted on the shaft 111 followed by a compression spring 228, one or more additional shims 226, and a rotatable grinding plate 220. Optionally, the one or more additional shims 226 may be mounted on the outside of the rotatable grinding plate 220, as shown. Alternatively, some or all of the shims 226 may be omitted. A tension nut 121 then finishes the assembly. The tension nut may typically be hand rotated to reach a desired balance between nut paste consistency (tighter produces a finer nut paste) and resistance to turning the crank 122 and/or pulley 126. Since the nut grinder 201 may at least optionally be operated using muscular energy of a person, the parts illustrated in FIGS. 2A, 2B are designed to minimize torque requirements while producing a maximum amount of nut butter.

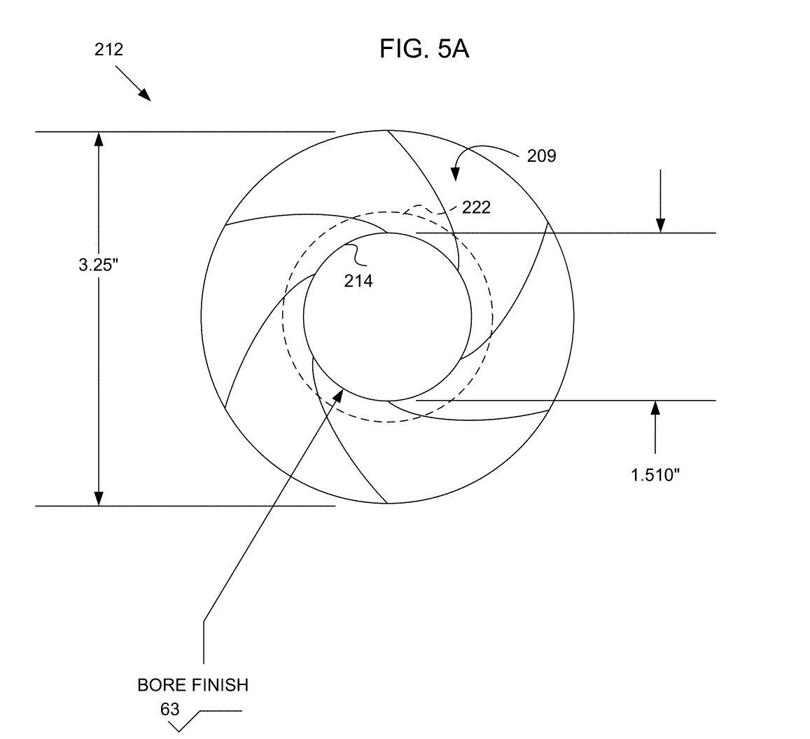

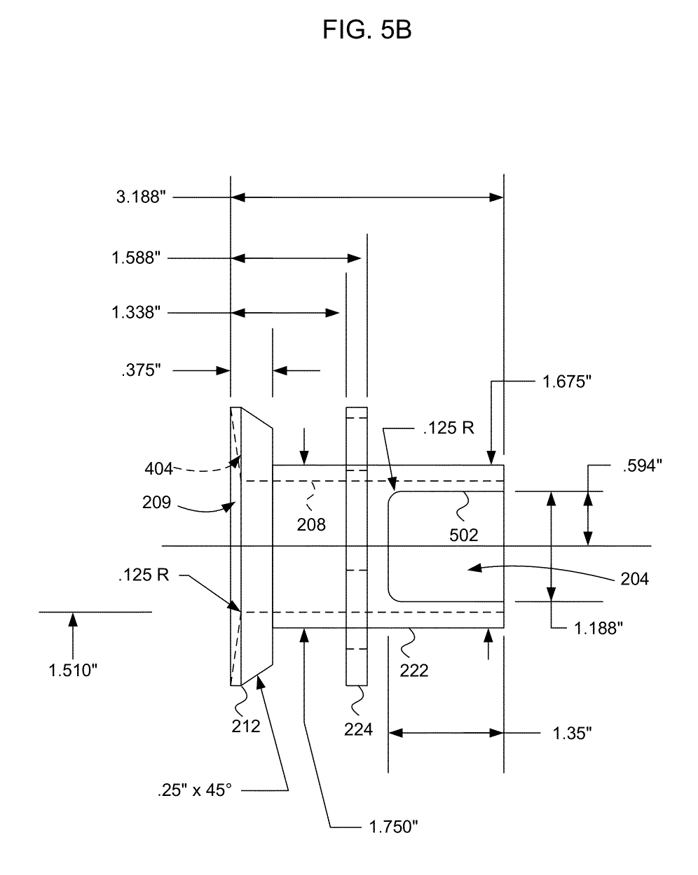

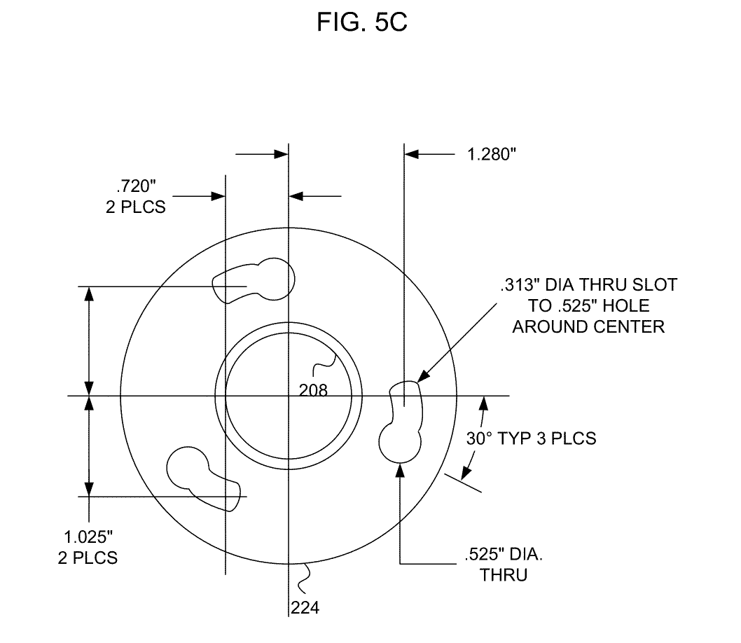

The nut grinder 201 may include at least one body 102, 222 including a wall 208 defining an axially symmetric conveying volume 204 having an input end 203, an output end 205, and an axis 207. As shown, the at least one body 102, 222 may include at least two bodies including a grinder body 102 including a wall 207 defining an outer conveying volume 104 (shown in FIG. 1B) and a sleeve 222 configured to mount at least partially inside the outer conveying volume 104. The wall defining the axially symmetric conveying volume 204 may be formed from an inner surface 208 of the sleeve 222. The sleeve 222 is described more fully in FIGS. 5A, 5B, and 5C and accompanying description below.

The axially symmetric conveying volume 204 may be formed as a cylindrical volume, for example. Optionally, with an appropriate change in shape of a nut auger 206, the axially symmetric conveying volume 204 may be formed as another axially symmetric shape, such as a truncated conical volume, an ellipsoidal volume, etc. The sleeve 222 may be formed from carbon steel or a stainless steel, for example. The grinder body 102 may be formed from a metal covered with a food-safe powder coating. According to an embodiment, the grinder body 102 may be formed as an investment cast or sand cast aluminum. As may be appreciated, grinding nuts may involve providing greater conveying force than grinding grain. Providing a sleeve 222 with an inner wall 208 defining the conveying volume 204 may help provide a system 201 that delivers greater satisfactory conveying force, compared to using the inner wall 107 of the grinder body 102 to define conveying volume 104, 204.

A first grinding surface 209 may be operatively coupled to at least one body 102, 222 and located adjacent to the output end 205 of the conveying volume 204. According to an embodiment, the first grinding surface 209 may be supported by a first grinding plate 212. According to an embodiment, the first grinding surface 209 may include a surface of a fixed grinding plate 212 that is mounted fixedly to the at least one body 102, 222, concentric and coplanar to the output end 205 of the conveying volume 204, as illustrated in FIG. 2B. Optionally, the first grinding plate 212 may be formed as a fixed grinding plate coupled to, configured for coupling to, or integral with the output end 205 of the sleeve 222.

As illustrated in FIG. 2B, the sleeve 222 may include an extension configured to support the first grinding plate 212 at a position away from the grinder body 102. Advantageously, this may help to reduce a potential mess and lost material compared to positioning the first grinding plate 212 within the dust shield, as with the first grinding plate 112 of the nut grinder 101 of FIGS. 1A, 1B. Whereas grinding a grain produces flour, grinding a nut may tend to form a paste, also referred to as nut butter. For example, grinding peanuts forms peanut butter. The resulting paste does not tend to fall out the bottom of the nip between the grinding plates, but rather extrudes out the entire periphery of the grinding plates 212, 220. By placing the nut grinding plates 212, 220 away from the grinder body 102, the extruded paste is free to break off and fall into a receptacle, rather than becoming a mess and adhering to the grinder body 102.

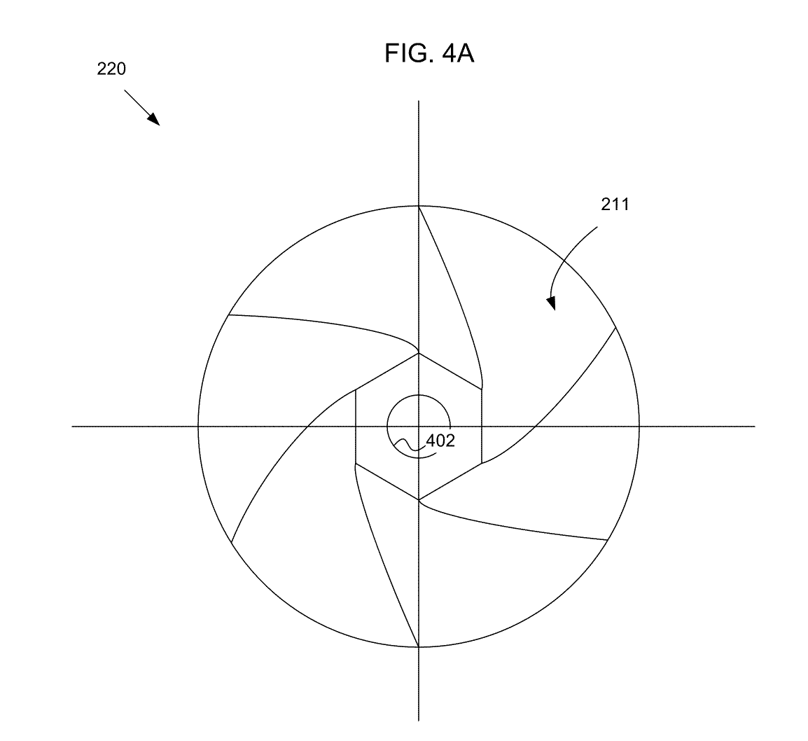

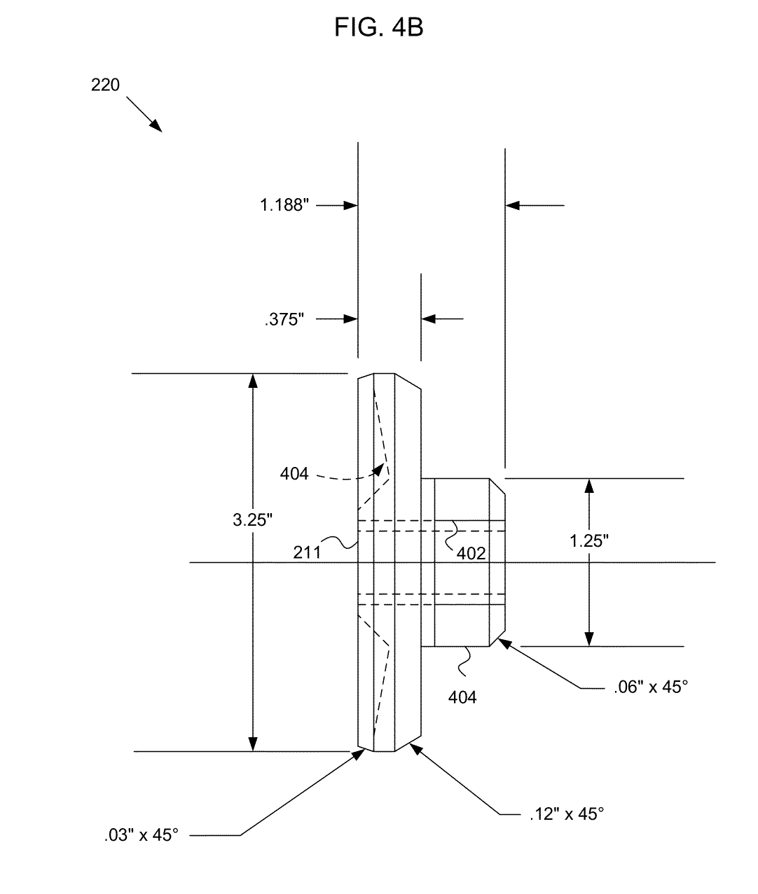

A second grinding surface 211 may be held in at least partial sliding rotational contact with the first grinding surface 209 and configured to at least optionally receive rotational motion from a person, such as via a shaft 111. The second grinding surface 211 may be supported by a rotatable grinding plate 220 that is coupled to rotate with the auger 206. The rotatable grinding plate 220 is described more fully in conjunction with FIGS. 4A and 4B.

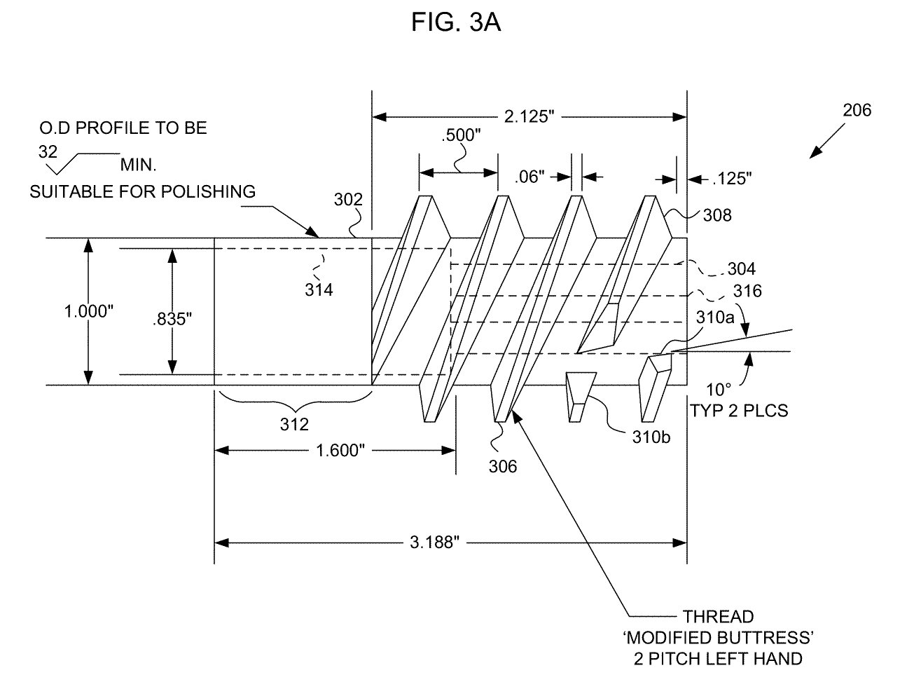

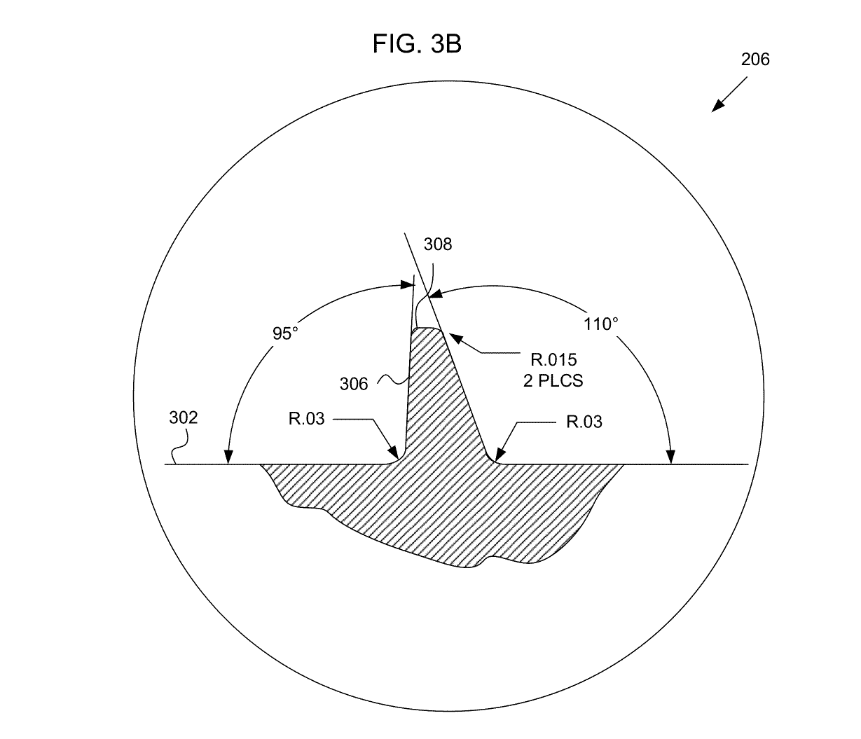

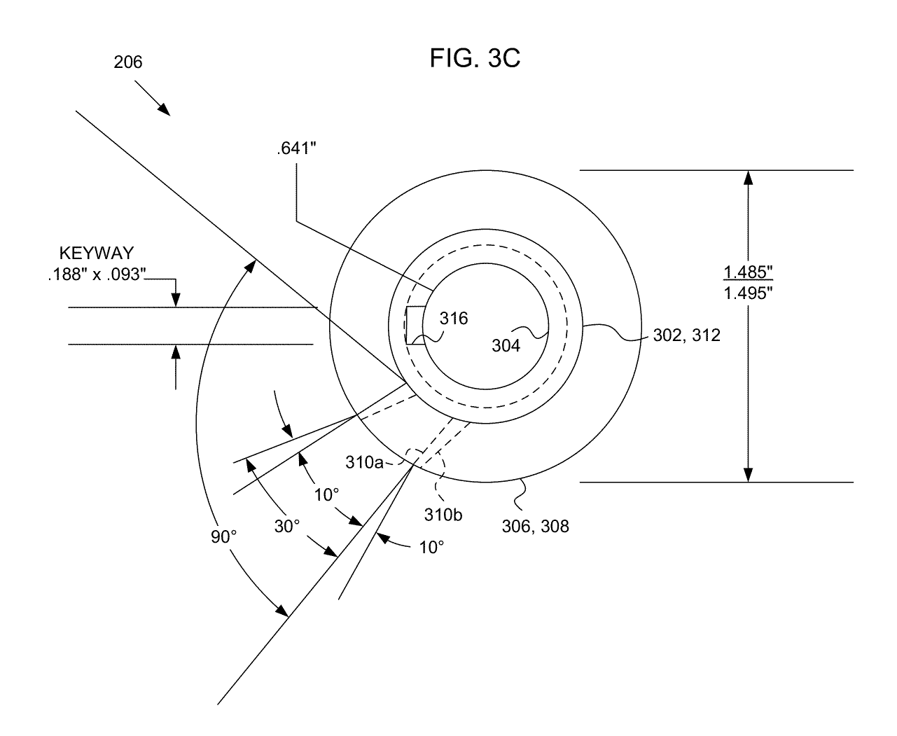

An auger 206 may be disposed coaxially 207 with and in the conveying volume 204, configured to at least optionally receive rotational motion from the person, such as via the shaft 111. The auger 206 may be configured to receive whole nuts responsive to only the force of gravity. The nuts may be fed from a hopper 108 at or near the input end 203 of the conveying volume 204 and the auger 206. The auger 206 (which may be regarded as cooperating with the sleeve 222 to form a screw conveyor) may be configured to convey the whole nuts or nuts sliced by the auger 206 to the output end 205 of the conveying volume 204 and the first 209 and second 211 grinding surfaces for grinding. An embodiment of the auger 206 is described more fully in conjunction with FIGS. 3A, 3B, and 3C.

According to an embodiment, the body 102, 222 that defines a cylindrical conveying volume 204 may be positioned to convey nuts from a hopper 108 to a nip between the stationary nut grinding plate 212 and the rotatable nut grinding plate 220. A shaft 111 is positioned axially to the conveying volume 204. The shaft 111 supports the nut auger 206 that turns with the shaft to urge nuts from the hopper 108 input end 203 of the conveying volume 204 through an inside diameter 214 (as shown in FIG. 5A) of the stationary grinding plate 212 at the output end 205 of the conveying volume 204. The nuts are then forced into a nip between the stationary nut grinding plate 212 and the rotatable nut grinding plate 220.

The nut auger 206 may have an outer diameter sufficiently close to an inner wall 208 of the sleeve 222 to substantially prevent whole or partially processed nuts from passing counter current to the direction of conveyance by the nut auger 206. An extension of the sleeve 222 is configured to couple between the grinder body 102 and the stationary nut grinding plate 212 to support the stationary nut grinding plate 212 and the rotatable nut grinding plate 220 at a position spaced away from the grinder body 102. The extension and the stationary nut grinding plate 212 are coupled to the body 102 by a collar 224.

The stationary nut grinding plate 212 and the rotatable nut grinding plate 220 are held in sliding rotational contact with one another. According to an embodiment, the stationary nut grinding plate 212 may be made substantially flat from its outer diameter with some concavity as it reaches its inner diameter 214. The rotatable nut grinding plate 220 may similarly be substantially flat across the outer perimeter of its grinding face, which is in contact with the stationary nut grinding plate 212, but having concave characteristics as it reaches its inner diameter 214. Such an embodiment is similar to the grain grinder 101 depicted in FIGS. 1A, 1B, wherein both the stationary grinding plate 112 and the rotatable grinding plate 120 are shaped with hollows that cooperate to form a receiving volume. The stationary and rotatable nut grinding plates 212, 220 may be about 3.25 inches in diameter.

The smaller outside diameter of nut grinding plates 212, 220 compared to the grain grinding plates 112, 120 may help to reduce torque and energy input requirements of the nut grinder 201. According to an embodiment, the nut grinding plates 212, 220 are 3.25 inches in diameter, compared to the grain grinding plates 112, 120, which are about 5 inches in diameter. In some embodiments, this can be important because both the grain grinder 101 and the nut grinder 201 are intended to at least optionally be operated by a person and not require electricity. The smaller diameter plates 212, 220 help keep the torque and energy requirements within levels that may be received from a person.

A person may rotate the shaft 111, the nut auger 206, and the rotatable nut grinding plate 220 with a hand crank 122. Nuts are forced into the nip between the stationary and rotatable nut grinding plates 212, 220 by the nut auger 206. The nut auger 206 may be formed with an inner end of the auger blade cut to have sharp edge configured to cut nuts it encounters during rotation. This feature is visible in FIGS. 3A, 3B. Typically, and in contrast to most grains, nuts are oily. During grinding, the nut oil is released and mixed with the nut solids to form a paste. The nut paste is typically referred to as nut butter. The nut butter is extruded from the nip at the outer diameter of the grinding plates 212, 220. The extension of the sleeve 222 moves the grinding plates 212, 220 away from the body 102 of the grinder and the dust shroud, and thus prevents the nut butter from extruding to and creating a mess inside a dust shroud that extends partially around the stationary grinding plate 112 and rotatable grinding plate 120 of FIGS. 1A, 1B.

Optionally, a user may provide an alternative power source to the shaft 111. For example, a v-groove pulley 126 operatively coupled to the shaft 111 may be coupled via a belt to an electric motor or a human-powered source of locomotion, such as a stationary bicycle.

FIG. 3A is a dimensioned side view of a nut auger 206 configured to convey nuts in the nut grinder 201 of FIGS. 2A, 2B, 6, and 7, according to an embodiment. FIG. 3B is a detail view of a thread of the auger 206 shown in FIG. 3A, according to an embodiment. FIG. 3C is a dimensioned end view of the nut auger 206 shown in FIGS. 3A and 3B, according to an embodiment. FIG. 3C is a view taken from the left (output) end of the nut auger 206 depiction of FIG. 3A.

In reference to FIGS. 3A, 3B, and 3C, the nut auger 206 may include an auger surface 302 that is spaced away from a bore 304 sized for a non-interfering fit over the shaft 111 (not shown in FIGS. 3A, 3B, and 3C). One or more threads 306 are machined in the auger 206 to extend from the auger surface 302 to an outer diameter 308. According to an embodiment, the auger surface 302 has a diameter of 1.0 inch, the outer diameter 308 of the threads 306 is 1.485 to 1.495 inches, and the inner diameter for seating on the shaft is 0.641 inch. The auger 206 may include two threads formed according to a modified buttress cross section, shown in detail in FIG. 3B. The threads may be 2 threads-per-inch left-hand. Referring to FIG. 2A, left-hand threads 306 may result in delivering nuts from the hopper 108 to the grinding plates 212, 220 when the crank 122 and/or pulley 126 is rotated counterclockwise when viewed from the grinding plate side of the grinder 201.

Cuts 310a, 310b are made in two places across the threads 306 as shown in FIGS. 3A and 3C. These cuts result in sharp edges 310a, 310b being formed in the threads 306. The edges 310a, 310b of the cuts may be referred to colloquially as “nut hooks”. It was found that including two nut hooks 310a, 310b located below the hopper at the angles and dimensions shown resulted in optimal non-aided passage of nuts from the hopper to the conveying volume. Without at least one nut hook 310a, 310b, it was found that for nut conveyance to work, one of two remedies needed to be implemented. Either the nuts needed to be chopped with a knife prior to putting the nuts in the hopper, or the nuts in the hopper needed to be manually pressed down with significant force to get them to feed through the nut grinder 201. Either remedy represents an inconvenience to the user.

As an option to one or more cuts 310a, 310b in the threads 306 of the nut auger 206, a separate nut cutter (not shown) may be included in the nut grinder 201. For example, a rotating knife edge may be geared to be driven from the auger 206 or the shaft 111 to cut the nuts, and thus satisfy receiving whole nuts responsive to only the force of gravity. But such an alternative may be less desirable than the cuts 310a, 310b shown, owing to greater cost, creation of a cutting hazard, incurring an increase in resistance to rotational motion, etc. Nevertheless, such alternatives may be considered to be within the scope and spirit of the disclosure and claims herein.

According to an embodiment, the threads end at a distance of 2.125 inches from the input end of the auger 206. A region near the output end of the auger 206 with no threads corresponds to a staging region 312 for the nuts. The staging region 312 was found to improve nut feeding and to minimize rotational power and torque required by the nut grinder. The staging region 312 appears to allow the nuts to self-assemble into a granular form adapted for easier transfer to the grinding surfaces, compared to a configuration without the staging region. A keyway 316 is used to lock the auger 206 onto the shaft 111 to ensure that the auger 206 turns with the shaft 111. Optionally, the keyway 316 may be substituted with a clutch. The auger 206 may be formed from 1040 or 1045 carbon steel, for example. Optionally, the auger 206 may be formed from 304 or 304L stainless steel.

Optionally, a spring pocket 314 allows insertion of a compression spring to stabilize the grinder assembly, according to the embodiment of FIGS. 2A and 2B. As will be described below, some embodiments maintain fit between the first and second grinding surfaces 209, 211 using an integral threaded coupling included in the second grinding plate 220. In such an embodiment, the cavity 314 in the nut auger 206 may function solely as a cavity and/or can be omitted such that the inside diameter of the nut auger 206 is constant.

FIG. 4A is a view of a grinding surface 211 of a rotatable grinding plate 220 configured to grind nuts in the nut grinder 201 of FIGS. 2A and 2B, according to an embodiment. FIG. 4B is a dimensioned side view of the rotatable grinding plate 220 of FIG. 4A, according to an embodiment. Referring to FIGS. 4A and 4B, the rotatable grinding plate 220 includes a bore 402 that is sized to hold the rotatable grinding plate 220 on the shaft 111 (see FIGS. 2A, 2B). Not shown is an optional keyway that may be used to maintain the rotatable grinding plate 220 in synchronous rotation with the shaft 111. The grinding surface 211 (also referred to as a second grinding surface herein) may include a region 404 visible in FIG. 4B that is depressed into the grinding plate. Typically, the grinding plate 220 may be formed by casting followed by machining to flatten the outer perimeter of the grinding surface 211. Machining may not affect the inner portion of the plate surface 211 because it includes the depression 404. The machined outer perimeter is the portion of the grinding plate 220 that is held in rotating, sliding contact with the first grinding surface 209 and the fixed grinding plate 212. The rotatable grinding plate 220 may be formed from 1040 or 1045 carbon steel, for example.

FIG. 5A is a dimensioned view of a grinding surface 209 of a fixed grinding plate 212 and an attached sleeve 222 configured for use in the nut grinder 201 of FIGS. 2A and 2B, according to an embodiment. FIG. 5B is a dimensioned side view of the fixed grinding plate 212 and attached sleeve 222 of FIG. 5A, according to an embodiment. FIG. 5C is a dimensioned view of a collar 224 of the sleeve 222 and attached fixed grinding plate 212 shown in FIGS. 5A and 5B, according to an embodiment. Referring to FIGS. 5A, 5B, and 5C, the grinding surface 209 of the fixed grinding plate 212 may be substantially the same as the grinding surface 211 of the rotatable grinding plate 220, except that an inner diameter 214 of the fixed grinding plate defines an innermost edge of the grinding surface 209. The inner diameter 214 of the fixed grinding plate may be formed at substantially the same radius as the sleeve wall 208. The depressed region 404 in the grinding surface 209 of the fixed grinding plate 212 (indicated in FIG. 5B) may be configured to cooperate with the corresponding depressed region 404 in the grinding surface 211 of the rotatable grinding plate 220 (indicated in FIG. 4B) to form a receiving volume for receiving a flow of nuts from the auger 206. Relatively “chunky” nuts, such as whole nuts or nuts sliced or mashed by the auger 206 may be able to enter the receiving volume defined by the depressed regions 404. As may be seen, the depressed regions 404 taper to meet the contacting portions of the grinding surfaces 209, 211. The “tooth” of the grinding surfaces 209, 211 in the depressed region performs an initial milling of the nuts and nut pieces, reducing their size. The reduced size nut pieces travel further toward the periphery of the grinding surfaces 209, 211 and through the contacting regions of the grinding surfaces 209, 211. In the process of this travel, nut pieces may be progressively classified to smaller and smaller pieces, extracting nut oils in the process, and forming a paste or “nut butter” that exudes from the peripheral edge of the contacting grinding surfaces 209, 211. Optionally, one or more deeper toothed features may be formed in the grinding surfaces 209, 211 to allow a fraction of the received nuts to be exuded as nut chunks. This may be used, for example, for making chunky peanut butter and the like.

Referring to FIG. 5B, an aperture 502 may be formed in the sleeve 222. The aperture 502 may be positioned (when assembled) below the hopper to admit the nuts into the axially symmetric conveying volume 204. It should be noted that the aperture 502, which may substantially be a missing region of the sleeve wall, should not be considered as inconsistent with the notion of an axially symmetric conveying volume 204. The conveying volume 204 itself may be considered axially symmetric whether or not one or more portions of the wall of the sleeve 222 may be missing. Rather, the concept of axial symmetry is such that the outer periphery 308 of a corresponding auger 206 may maintain a substantially constant clearance from the wall in places where the wall is present such that the auger 206 may be rotated about the axis without encountering a mechanical interference. One or more grooves, dimples, or other features may similarly be formed in the surface 208 of the wall of the sleeve 222 without destroying the axial symmetry of the conveying volume 204.

Optionally, the aperture 502 and the auger 206 thread(s) 306, and/or the aperture 502 and the sharp feature(s) 310a, 310b in the auger 206 thread(s) 306, may cooperate to form a scissor-like effect wherein nuts received from the hopper are automatically sliced, pre-milled, ground, scraped, or otherwise altered to promote induction of the nuts into the axially symmetric conveying volume 204. As may be seen in the depicted illustrative embodiment 222, the axially symmetric conveying volume may be substantially cylindrical.

Referring especially to FIGS. 5B and 5C, a mounting collar 224 may be formed to mount the sleeve 222 on the grinder body 102. Typically, the slots and holes depicted in FIG. 5C are formed to allow mounting of the mounting collar 224 and the sleeve 222 using tapped holes (not shown) used to mount the fixed grinding plate 112 of the grain grinder 101. In the case of using non-countersunk screws, the nut grinder kit described below may include the replacement screws. To mount the sleeve 222, the screws (not shown) are typically started into the tapped holes (not shown) in the grinder body 102; the holes of the mounting collar 224 are inserted over the screw heads; and the sleeve 222 and the mounting collar 224 are rotated clockwise through the slots to capture the mounting collar 224. The screws (not shown) may then be tightened to solidly mount the sleeve 222 and the mounting collar 224 to the grinder body 102.

The sleeve 222 may be formed from 1040 or 1045 carbon steel, for example.

Optionally, the grinding surfaces 209, 211 may be formed in a different configuration than the embodiment 212, 220 illustratively described herein. For example, the grinding surfaces 209, 211 may be configured as concentric tubular/cylindrical surfaces, ellipsoidal or spherical surfaces, conical surfaces, paraboloids of revolution, or another grinding surface pair configured to grind nuts. Embodiments may be selected to be driven with a power and/or torque within a range available from a person.

Optionally, according to an embodiment, a kit for converting a grain grinder 101 into a nut grinder 201 may include the sleeve 222 and a fixed grinding plate 212 coupled to, configured for coupling to, or integral with the output end of the sleeve 222 as illustratively depicted in FIGS. 5A, 5B, and 5C; the nut auger 206 such as the illustrative embodiment shown in FIGS. 3A, 3B, and 3C; and the rotatable grinding plate 220 such as the embodiment shown in FIGS. 4A and 4B. The kit may include a spring 228 configured to couple between the nut grinder body 102 and the rotatable grinding plate in compressive balance with the shaft 111. Typically, (referring to FIG. 1A) the compression nut 121, shim(s) 226, shaft 111, and grain grinder body 102 from the grain grinder may be provided by the user by salvaging the parts from the grain grinder 101, and (unless for repair purposes, for example) such parts that are common between the grain grinder 101 and nut grinder 201 configurations may be omitted from the kit. Optionally, one or more alternative nut slicing assemblies may be included in the kit. Optionally, as with the nut grinder 201 itself, the grinding surfaces may be a different configuration than the embodiment 212, 220. For example, the grinding surface may be configured as concentric tubular/cylindrical surfaces, ellipsoidal/spherical surfaces, conical surfaces, or another grinding surface pair configured to grind nuts and driven with a power and/or torque within a range available from a person. The kit may be configured to cause the resultant assembly 201 to operate as described elsewhere herein.

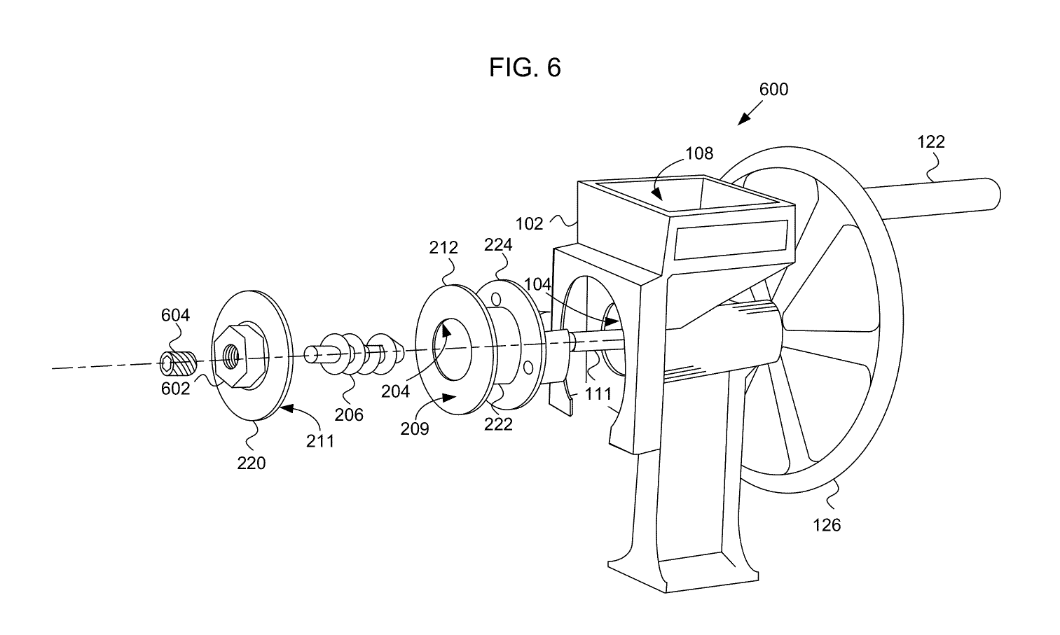

In another embodiment, the kit may include a sleeve 222 and provide coupling between the shaft 111, nut auger 206, and rotatable grinding plate 220 according to the no-spring arrangement 600 shown in FIG. 6. In this case, the kit can include the sleeve 222, a fixed (first) grinding plate 212 coupled to the output end of the sleeve 222, the nut auger 206, the rotatable (second) grinding plate 220 including an integral threaded coupling 602, and a set screw 604.

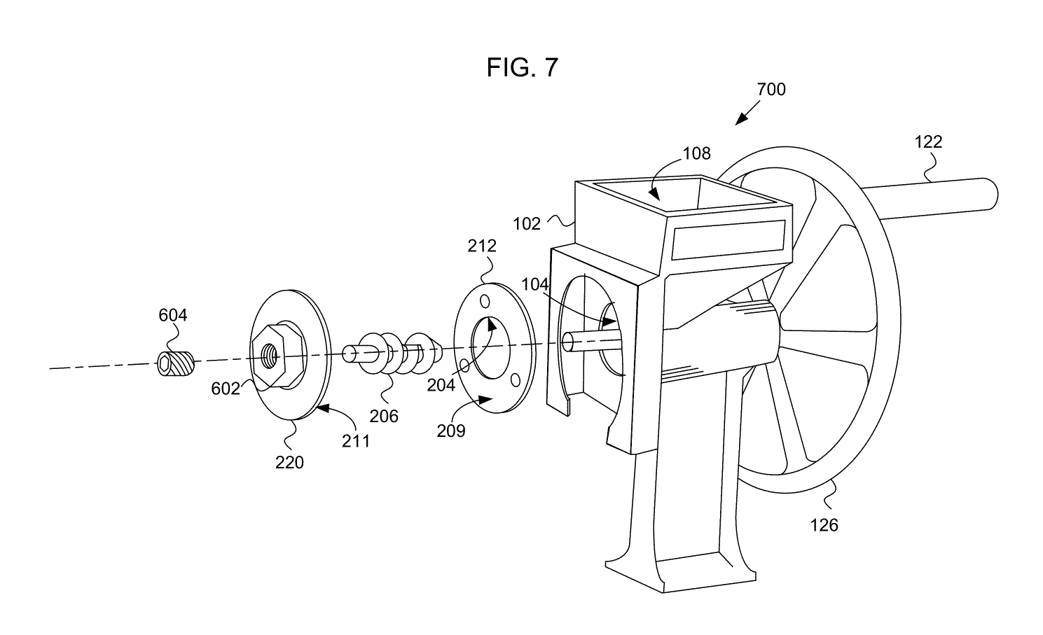

In another embodiment, the kit may be configured as shown in FIG. 7, wherein the sleeve 222 is omitted. In such a case, the kit can include a fixed (first) grinding plate 212 (e.g., having a smaller diameter than a grain grinding plate), the nut auger 206, the rotatable (second) grinding plate including the integral threaded coupling 602, and the set screw 604.

The kit for converting a grain grinder 101 into a nut grinder 201, 600, or 700 may further include printed instructions (not shown) adapted to instruct a user how to convert the grain grinder 101 into a nut grinder 201, 600, 700, and back again.

FIG. 6 is a perspective exploded view of a nut grinder 600 configured to grind nuts, according to another embodiment. The term “nut mill”, as used herein, is synonymous with the term “nut grinder.” The nut grinder 600 includes a body 102 that defines a cylindrical passage extending from an input end disposed to receive nuts from a hopper 108 to an output end. A sleeve 222 including an inner wall 204 is configured to slide into the cylindrical passage. The sleeve 222 is mounted on the grinder body 102 with a collar 224 such that the sleeve 222 and the cylindrical passage are concentric to one another, and the inner wall 204 of the sleeve 222 defines an outer diameter of a conveying volume 104.

A first (stationary) grinding surface 209 is formed on a first (stationary) grinding plate 212 operatively coupled to the sleeve 222. For example, the first grinding plate 212 may be mechanically coupled to the sleeve 222 with fasteners such as countersunk screws.

A shaft 111 is supported by bearings at a position axial to the conveying volume 104, the shaft being configured to receive rotational motion from an external source. A nut auger 206 is configured for support by the shaft 111. As described above (e.g., see FIG. 3A), a keyway 316 or a clutch fitting can be used to lock the nut auger 206 onto the shaft 111 to couple the auger 206 to turn with the shaft 111.

A second, moving, grinding plate 220 defines a second grinding surface 211 configured for sliding rotational contact with the first grinding surface 209. The second grinding plate 220 may include an integral threaded coupling 602 configured for screwing onto a threaded end of the shaft 111. A fitting such as an integral hex nut can be provided to allow a wrench to be used to rotate the second grinding plate 220 into a desired pressure against the first grinding plate 212 and to hold the second grinding plate 220 in position while a set screw 604 is tightened. The set screw 604 (such as an Allen screw or hex socket screw) can be screwed into the integral threaded coupling 602 of the second grinding plate 220 to jamb against an end of the shaft 111, thereby locking the second grinding plate 220 into position.

The stationary grinding plate 212 is positioned circumferentially to the shaft 111 such that nuts may pass through an inner diameter of the stationary grinding plate 112. In operation, the nuts are conveyed from the hopper 108 by the nut auger 206 to a receiving volume (see 404, FIG. 4B) formed between depressions in grinding surfaces 209, 211 of the stationary grinding plate 212 and the rotatable grinding plate 220.

The nut mill 600 can be powered by human power (e.g., via a hand crank 122) or by a small electric motor. In one example, a small electric motor (not shown) can be coupled to a crank end of the shaft 111. In another embodiment, a person or a small electric motor can provide rotational movement to the shaft 111 via a V-belt operatively coupled to a crank wheel.

The nut grinder 600 can optionally include portions of the grain grinder 101 of FIGS. 1A, 1B, for example, by removing some parts and installing a conversion kit, described above.

FIG. 7 is a perspective exploded view of a nut grinder 700 configured to grind nuts, according to another embodiment. Compared to the embodiment 600 FIG. 6, the nut grinder 700 does not include a sleeve 222. Instead, the cylindrical conveying volume 104 is defined by walls formed in the nut grinder body 102.

In the embodiment 700, the diameter of the threads of the nut auger 206 are selected to be slightly smaller than a diameter of the walls of the cylindrical conveying volume 104. The first (stationary) grinding plate 202 is operatively coupled to the body 102 circumferential to the cylindrical conveying volume 104. In one embodiment, countersunk stainless steel screws are recessed into the first grinding plate 212 below the grinding surface 209 to couple to corresponding tapped holes (not shown) in the body 102.

Other aspects of the description corresponding to FIG. 6 apply to FIG. 7.

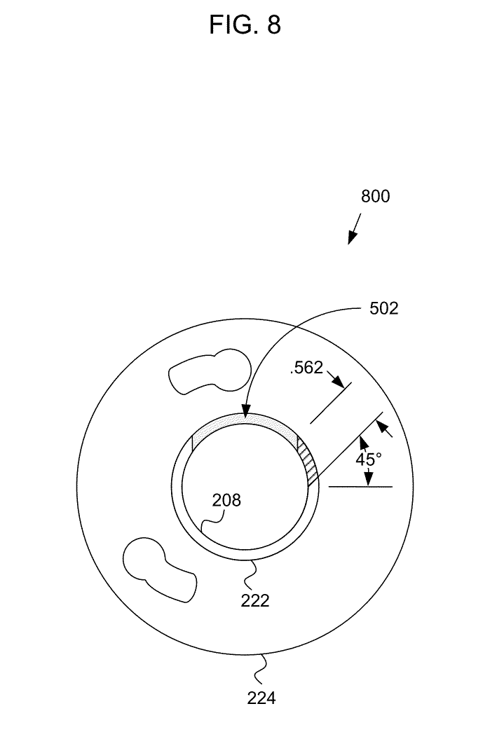

FIG. 8 is an end view of a nut grinder sleeve 222, according to an alternative embodiment 800. Referring to FIG. 5B, the inventors found that changing an angular dimension of the opening aperture 502 in the sleeve 222 resulted in a significant increase in nut butter production, compared to the aperture 502 dimension illustrated in FIG. 5B. Referring again to FIG. 8, the aperture 502 can be made asymmetric. In particular, the far side of the aperture 502 in the sleeve 222, as depicted in FIG. 6, was cut back by a distance 0.562 inch, as shown in FIG. 8, leaving a 45° bevel on the sleeve wall. As may be seen, the edge of the aperture extends about 90° from a vertical centerline of a feed path from the hopper. For an equivalent number of revolutions, nut butter production was increased by about 20% compared to a nut grinder equipped with a sleeve having a symmetric aperture 502.

The aperture 502 provides an expanded diameter into which nuts received from the hopper are rotated by the auger 206. Upon reaching an extended edge of the aperture 502, nuts are forced into a groove defined by threads of the auger 206. Because nuts encountering the extended edge of the aperture 502 are rotated away from the hopper inlet, resistance to the edge defined by the extended aperture does not result in nuts being driven upward into the hopper. The lack of nuts being at least occasionally being driven upward into the hopper is believed to be related to the increased throughput of a nut grinder equipped with a sleeve embodiment 800.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A nut grinder, comprising:
a body defining a cylindrical conveying volume having an input end, an output end, and an axis;
a first grinding plate defining a first grinding surface operatively coupled to the body and disposed adjacent to the output end of the conveying volume;
a shaft axial to and configured to rotate in the conveying volume;
a second grinding plate defining a second grinding surface operatively coupled to the shaft, configured to be held in at least partial sliding rotational contact with the first grinding surface, and configured to receive rotational motion from the shaft; and
a nut auger disposed coaxially with and in the conveying volume, configured to receive rotational motion from the shaft, configured to receive nuts from a hopper at or near the input end of the conveying volume, and configured to convey the nuts to the output end of the conveying volume to a receiving volume defined by the first and second grinding surfaces.

2. The nut grinder of claim 1, wherein the body defines an outer volume; and
further comprising:
a sleeve configured to be inserted into the outer volume;
wherein an inner wall of the sleeve defines an outer diameter of the cylindrical conveying volume.

3. The nut grinder of claim 2, wherein the sleeve defines an aperture configured to receive nuts from the hopper; and
wherein the aperture is asymmetric with respect to the hopper.

4. The nut grinder of claim 2, wherein the aperture extends a distance away from the hopper.

5. The nut grinder of claim 2, wherein the aperture extends about 90° from a vertical centerline of a feed path from the hopper.

6. The nut grinder of claim 2, wherein the sleeve further comprises an extension configured to support the first grinding plate at a position away from the grinder body.

7. The nut grinder of claim 1, wherein the body defines an outer diameter of the cylindrical conveying volume.

8. The nut grinder of claim 1, wherein the first and second grinding plates are formed from steel.

9. The nut grinder of claim 1, wherein the nut auger includes a thread; and
wherein the thread is cut in at least one place near the input end;
wherein the cut is configured to slice nuts received from the hopper.

10. The nut grinder of claim 8, wherein the thread is cut in two places.

11. The nut grinder of claim 1, further comprising:
a crank, pulley, or crank and pulley operatively coupled to the shaft and configured to receive the rotational motion from a person.

12. The nut grinder of claim 1, wherein:
the shaft includes a screw thread; and
the second grinding plate includes an internal thread configured to couple to the screw thread on the shaft.

13. The nut grinder of claim 12, further comprising:
a set screw configured to hold the second grinding plate in position relative to the shaft.

14. A method for grinding nuts, comprising:
receiving nuts from a hopper by gravity feed alone;
rotating a nut auger to convey the received nuts to a receiving volume defined between a pair of grinding surfaces defined by respective grinding plates; and
extruding a nut butter from a region between outer edges of the grinding surfaces;
wherein one of the grinding plates is stationary and the other of the pair of grinding plates rotates synchronously with the nut auger.

15. The method for grinding nuts of claim 14, wherein the nut auger and the rotating grinding plate receive rotational motion constrained to a power and torque within a range available from one person.

16. The method for grinding nuts of claim 14, wherein receiving nuts from a hopper by gravity feed alone includes rotating a sharp edge of the nut auger past the hopper, and cutting the nuts with the sharp edge of the nut auger.

17. The method for grinding nuts of claim 16, wherein cutting the nuts with the sharp edge of the nut auger includes slicing the nuts between the sharp edge of the nut auger and an edge of an aperture formed in a sleeve concentric to the nut auger.

18. The method for grinding nuts of claim 17, further comprising:
receiving the nuts into a diameter larger than the sleeve; and
rotating the nuts away from the hopper before slicing the nuts.

19. The method for grinding nuts of claim 18, wherein rotating the nuts away from the hopper before slicing the nuts includes rotating the nuts about 90° from a centerline of the hopper.
